(19) United States
(12) Patent Application Publication
(10) Pub. No.: US 2025/0229721 A1
(43) Pub. Date: Jul. 17, 2025

(54) VEHICLE AND MOUNT BAR

(71) Applicant: KAWASAKI MOTORS, LTD., Akashi-Shi (JP)

(72) Inventors: Kota HIDAKA, Akashi-Shi (JP); Hidefumi YASUHARA, Akashi-Shi (JP); Daisuke SAEKI, Lincoln, NE (US); Loran FORTIK, Lincoln, NE (US); Chase NICKLE, Lincoln, NE (US)

(73) Assignee: KAWASAKI MOTORS, LTD., Akashi-Shi (JP)

(21) Appl. No.: 18/413,220

(22) Filed: Jan. 16, 2024

(51) Int. Cl. B60R 7/06

(52) U.S. Cl. CPC B60R 7/06

(57) ABSTRACT

A vehicle includes a dashboard, and a mount bar formed along the dashboard. The mount bar includes a rod-shaped main body whose cross-sectional contour is circular.

### BACKGROUND OF THE INVENTION

### Field of the Invention

This disclosure relates to a vehicle and a mount bar.

### Background Art

U.S. Pat. No. 6,321,960 B1 discloses a dashboard attachment system for a vehicle. The dashboard attachment system for a vehicle includes a flat rail disposed rearward away from a dashboard.

### SUMMARY

A vehicle according to one aspect includes: a dashboard; and a mount bar including a rod-shaped main body whose cross-sectional contour is circular, the mount bar being formed along the dashboard.

In this vehicle, various accessories can be attached to the mount bar with attitudes desired by the user, which can increase the convenience of the user.

The objects, features, aspects, and advantages of this disclosure will become more apparent from the following detailed description and the accompanying drawings.

### BRIEF DESCRIPTION OF THE DRAWINGS

FIG. 1 is a side view illustrating a vehicle according to an embodiment.

FIG. 2 is a perspective view illustrating a mount bar and its surroundings in the vehicle in FIG. 1.

FIG. 3 is a plan view illustrating the mount bar and its surroundings in the vehicle in FIG. 1.

FIG. 4 is a rear view illustrating the mount bar and its surroundings in the vehicle in FIG. 1.

FIG. 5 illustrates a cross-sectional view taken along the line V-V of FIG. 3.

FIG. 6 illustrates a cross-sectional view taken along the line VI-VI of FIG. 3.

FIG. 7 illustrates a view from a direction along an arrow sign A1 in FIG. 1.

FIG. 8 is a perspective view illustrating a connection portion between the mount bar and a pillar.

FIG. 9 is a rear view illustrating a state in which the mount bar has been removed.

FIG. 10 illustrates examples of accessories to be attached to the mount bar.

### DESCRIPTION OF THE PREFERRED EMBODIMENTS

### Embodiment

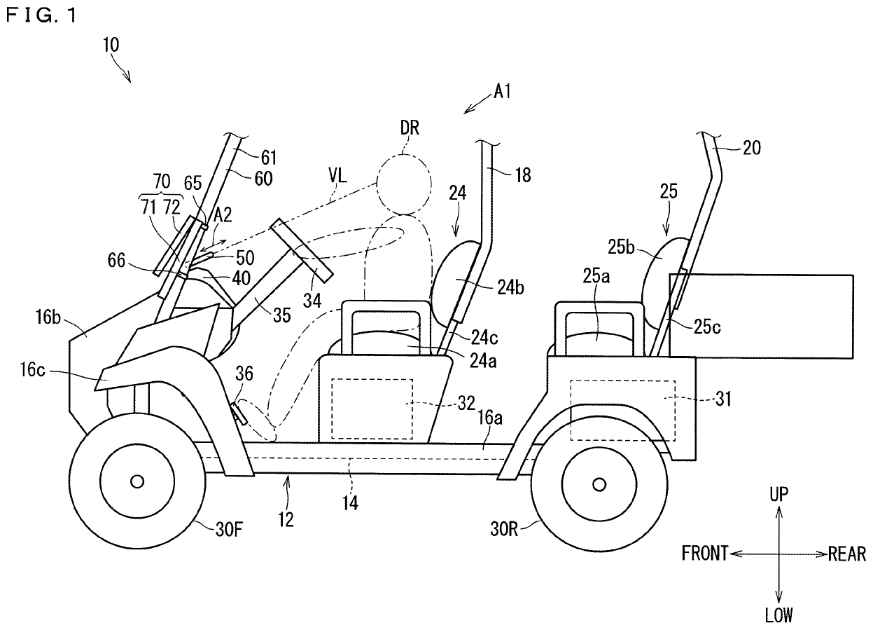

A vehicle according to an embodiment will be hereinafter described. FIG. 1 is a side view illustrating the vehicle according to the embodiment. In the following description, traveling directions of the vehicle 10 may be expressed as forward, backward opposite to the forward direction, downward toward road surfaces on which the vehicle 10 travels, and upward opposite to the downward direction. The right and left may be referred to while a person stands on a road surface and faces forward. The lateral direction is a vehicle-width direction.

The vehicle 10 may be a single-seater vehicle or a multi-seater vehicle. The vehicle 10 may have only a seat or seats in a forward and backward direction. Since the vehicle 10 is a vehicle designed to travel through, for example, private roads or private lands at low speeds, the vehicle 10 may have open right and left passenger entrances to seats without being obstructed by walls or doors to facilitate the occupants getting on or off the vehicle 10. Here, the occupants can walk past in a lateral direction without being obstructed by doors or walls.

### [Overall Structure of Vehicle]

The vehicle 10 includes a vehicle body 12 including a dashboard 40, and a mount bar 50. The vehicle 10 according to the embodiment further includes seats 24 and 25, a traveling mechanism, and a driving operation mechanism.

The vehicle body 12 may have a frame structure or a monocoque structure. This embodiment will be described assuming that the vehicle body 12 has a frame structure. The vehicle body 12 includes a frame 14 and panels. The frame 14 is structured by combining, for example, metallic pipe components, sheet metal components, or cast components. The panels cover the frame 14 and various components supported by the frame 14. The panels give the appearance of the vehicle 10, and partition spaces in the vehicle 10. Examples of the panels include a floor panel 16a, a hood 16b, and fenders 16c. The floor panel 16a is located at the bottom of the occupant space. The hood 16b is located more forward than the dashboard 40. The fenders 16c are located at both outside portions of the hood 16b in the lateral direction.

Each of the seats 24 and 25 is a part on which occupants are to be seated. The seats 24 and 25 are located on the floor panel 16a. The vehicle body 12 supports the seats 24 and 25. The seats 24 and 25 are apart from each other in the forward and backward direction. The seat 24 is located more forward than the seat 25. The seat 24 includes a seat cushion 24a, a back rest cushion 24b, and a seat frame 24c. Similarly, the seat 25 includes a seat cushion 25a, a back rest cushion 25b, and a seat frame 25c. The seat frames 24c and 25c can be considered as parts of the frame 14 in the vehicle body 12. Outside right and left portions of the seats 24 and 25 are openings through which occupants get on and off the vehicle 10. The vehicle 10 is intended to normally travel with the openings being opened and not closed by, for examples, doors.

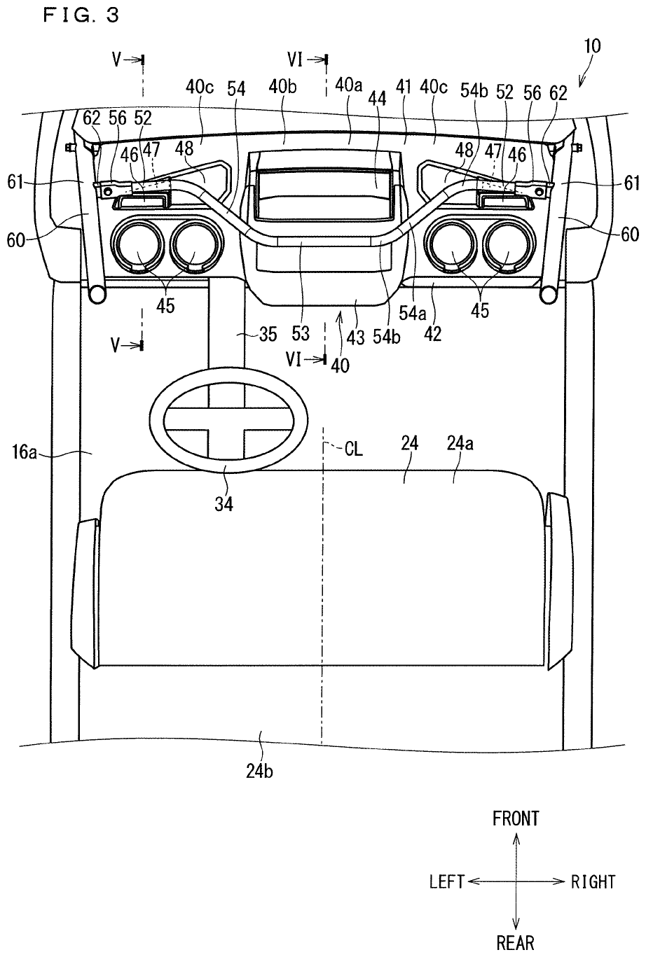

The seats 24 and 25 are bench seats on which persons can be seated side by side in the vehicle-width direction. A driver seat on one side in the vehicle-width direction and an assistant driver seat on the other side in the vehicle-width direction are disposed to sandwich a middle in the vehicle-width direction. A center line CL in FIG. 3 is a line passing through the middle in the vehicle-width direction and extending in the forward and backward direction. Here, a portion of the seat 24 on one side with respect to the center line CL in the vehicle-width direction is considered as the driver seat, and a portion of the seat 24 on the other side is considered as the assistant driver seat. The seat 24 may have a structure in which the driver seat and the assistant driver seat are independently formed.

The traveling mechanism is a mechanism for traveling of the vehicle 10, and includes wheels 30F and 30R, a traveling motor 31, and a power transmission mechanism. Transmission of rotation drive force of the traveling motor 31 to the wheels 30F and 30R through the power transmission mechanism allows the vehicle 10 to travel. This embodiment describes an example in which the vehicle 10 includes the four wheels 30F and 30R. The vehicle 10 may include three or six wheels. The structure of the power transmission mechanism is discretionary. Examples of the power transmission mechanism may include a transmission and a drive shaft.

The wheels 30F and 30R include front wheels 30F and rear wheels 30R, respectively. The two front wheels 30F are rotatable around its own central axis and are supported to be rotatable around a steering axis, at right and left front portions of the vehicle body 12. The two rear wheels 30R are supported to be rotatable around its own central axis at right and left rear portions of the vehicle body 12.

In this embodiment, the traveling motor 31 is an electric motor that converts electric energy into rotational motion for traveling. Here, the vehicle 10 includes a traveling battery 32 for supplying the electric energy to the traveling motor 31. For example, the traveling battery 32 is supported at a lower portion of the seat 24, and the traveling motor 31 is supported at a lower portion of the seat 25. The traveling motor 31 may be an internal combustion engine that burns fuel in a combustion chamber and generates power for traveling through expansion of gases from the burnt fuel. Here, the vehicle 10 should include a fuel tank. The positions of the traveling motor 31 and the traveling battery 32 are discretionary.

The driving operation mechanism is a mechanism for receiving a driving operation from a driver DR, and includes, for example, a steering wheel 34 and pedals 36. The operation of the steering wheel 34 by the driver DR enables the front wheels 30F to rotate around the steering axis. The driver DR can operate an accelerator and a brake through operations of the pedals 36. The steering wheel 34 and the pedals 36 are located more forward than the seat 24. The driver DR seated on the seat 24 can operate the steering wheel 34 and the pedals 36. For example, a steering column 35 protrudes rearward from the dashboard 40, and the steering wheel 34 is supported at the end of the steering column 35. The pedals 36 are located below the steering wheel 34. The pedals 36 may be an accelerator pedal and a brake pedal that are separately provided. One pedal may operate both of the accelerator and the brake.

The mount bar 50 is a component supporting an accessory AC when the user adds the accessory AC. The mount bar 50 is disposed along the dashboard 40. Specifically, the mount bar 50 is formed into a shape of an upper surface of the dashboard 40 while the mount bar 50 is attached to the vehicle body 12. More specifically, the mount bar 50 is formed to conform to a shape of an upper edge of the dashboard 40. In this embodiment, the upper edge of the dashboard 40 is formed such that the height of the dashboard 40 varies toward the vehicle-width direction. Thus, the mount bar 50 is formed such that the height of the mount bar 50 varies toward the vehicle-width direction, similarly to the upper edge of the dashboard 40. In this embodiment, the upper edge of the dashboard 40 is also formed such that the position of the dashboard 40 in the forward and backward direction varies toward the vehicle-width direction. Thus, the mount bar 50 is formed such that the position of the mount bar 50 in the forward and backward direction varies toward the vehicle-width direction, similarly to the upper edge of the dashboard 40.

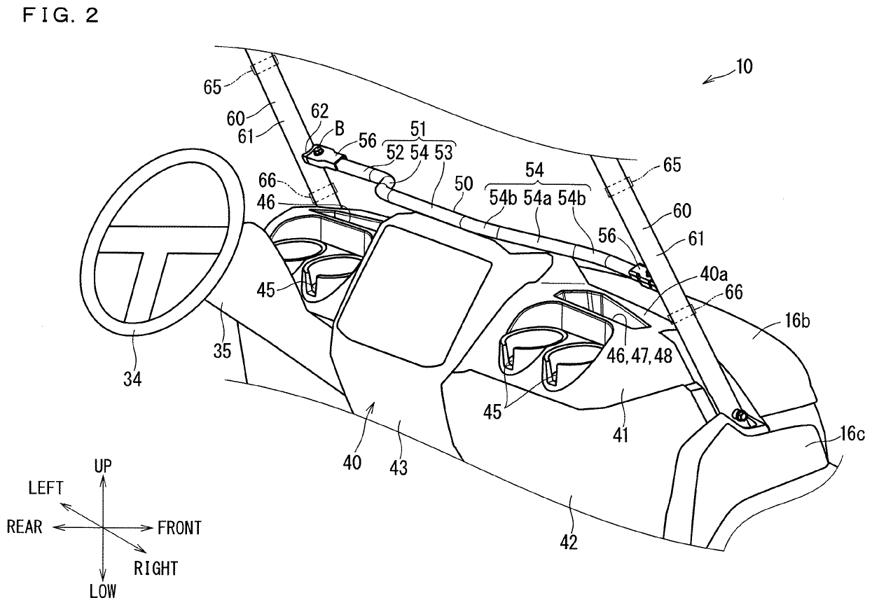

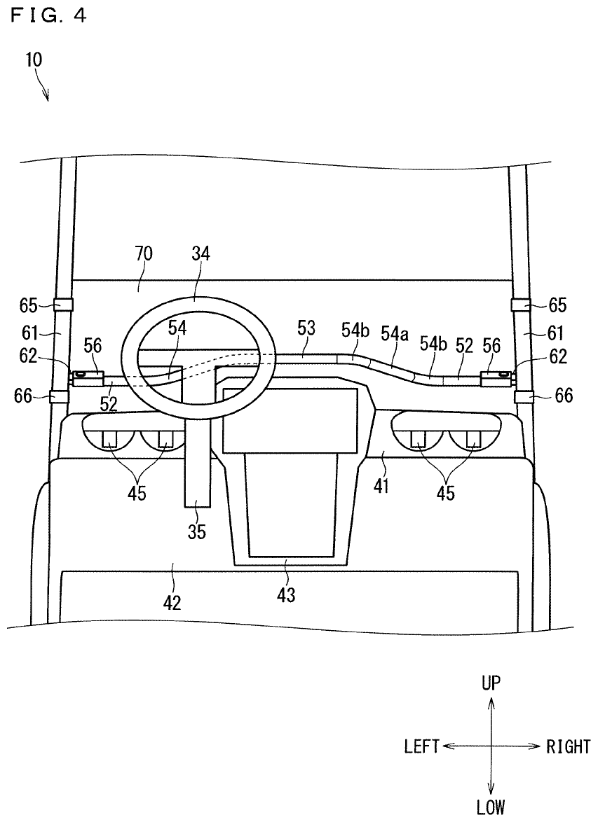

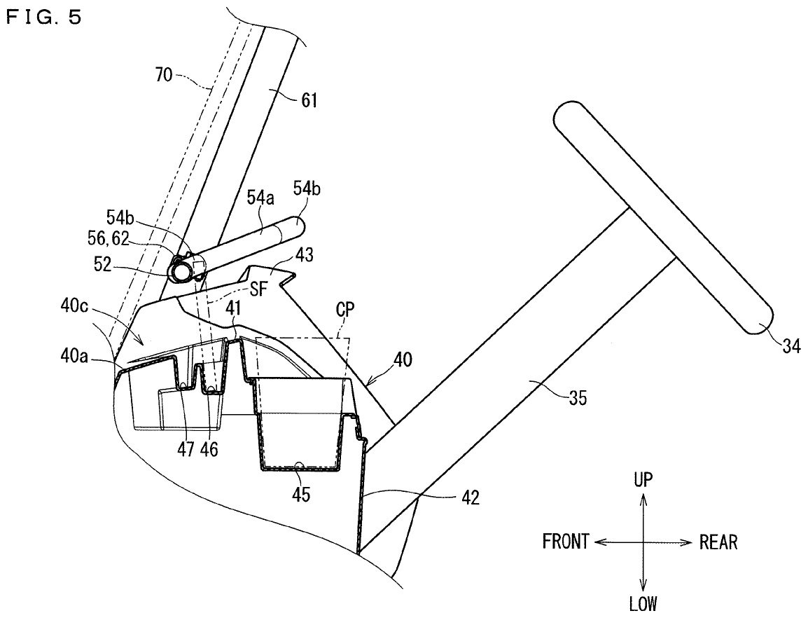

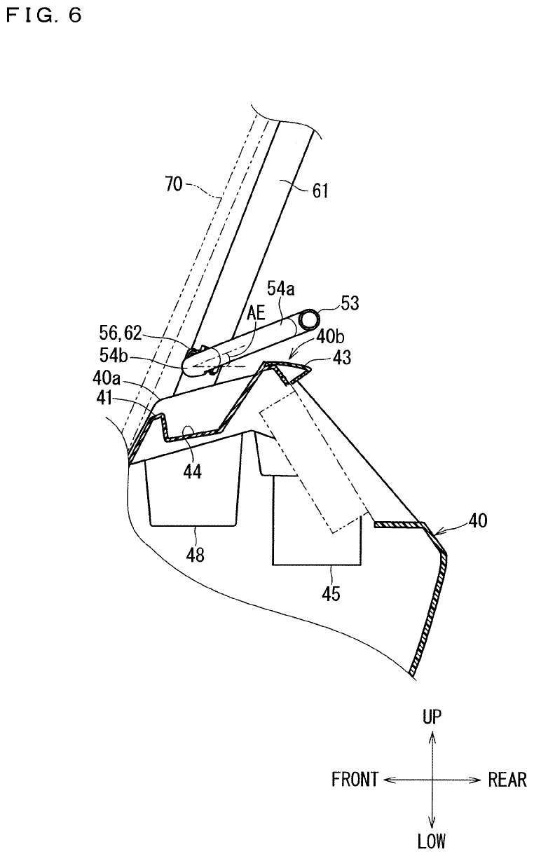

The dashboard 40, the mount bar 50, and its surrounding structure in the vehicle will be described. FIG. 2 is a perspective view illustrating the mount bar 50 and its surroundings in the vehicle 10 in FIG. 1. FIG. 3 is a plan view illustrating the mount bar 50 and its surroundings in the vehicle 10 in FIG. 1. FIG. 4 is a rear view illustrating the mount bar 50 and its surroundings in the vehicle 10 in FIG. 1. FIG. 5 illustrates a cross-sectional view taken along the line V-V of FIG. 3. FIG. 6 illustrates a cross-sectional view taken along the line VI-VI of FIG. 3.

The dashboard 40 is disposed in front of a riding space in which a driver and an occupant are located, and functions as a partition that separates the riding space from a vehicle-front internal space located more forward than the riding space. The front internal space is a space below a front hood 16b. The dashboard 40 may include an instrument panel, a glove box, various switches, and an indicator. The dashboard 40 according to the embodiment includes an upper surface portion above a floor panel region on which toes of the driver and the occupant are placed. The upper surface portion of the dashboard 40 protrudes more rearward than the front hood 16b. The upper surface portion of the dashboard 40 according to this example protrudes more rearward than pillars 60.

As illustrated in FIG. 2, the dashboard 40 includes, for example, upper panels 41, lower panels 42, and a center panel 43. For example, the upper panels 41, the lower panels 42, and the center panel 43 are resin parts separately molded. The upper panels 41 are front and upper portions of the dashboard 40. The lower panels 42 are rear and lower portions of the dashboard 40. The center panel 43 is a center portion of the dashboard 40, and extends from a forward and upward direction toward a rearward and downward direction. In this embodiment, a monitoring instrument that displays various information such as navigation information is incorporated into the center panel 43. Furthermore, the various switches for operating the monitor and for vehicle control are incorporated into the center panel 43 in this embodiment. The external surfaces of the upper panels 41 face upward. The external surfaces of the lower panels 42 face rearward. The external surface of the center panel 43 includes a portion facing upward and a portion facing rearward. The portion facing upward on the external surface of the center panel 43 and the external surfaces of the upper panels 41 form a main portion of an upper surface 40a of the dashboard 40.

The upper surface 40a of the dashboard 40 is formed such that the height of the dashboard 40 varies toward the vehicle-width direction, from one end toward the other end in the vehicle-width direction. In the upper surface 40a of the dashboard 40 according to this embodiment, a middle portion 40b is higher than side portions 40c more outside than the middle portion 40b in the vehicle-width direction. In other words, the upper surface 40a of the dashboard 40 is formed such that the height of the dashboard 40 increases from one end and the other end toward the middle in the vehicle-width direction. In this embodiment, the middle portion 40b higher than the remaining portions of the dashboard 40 in the vehicle-width direction is formed to correspond to the center panel 43. Forming the center panel 43 higher than the remaining portions facilitates upsizing the monitor, increasing the number of switches or upsizing the switches for easier operations. In this embodiment, a rear surface of the center panel 43 protrudes more rearward than rear surfaces of the remaining upper panels 41 in the dashboard 40. This can bring, for example, the monitor, the various switches, and the indicator included in the center panel 43 closer to the driver, and can increase the usability or the visibility.

The upper surface 40a of the dashboard 40 includes recesses each with an upper opening for housing an object. The upper surface 40a in this embodiment includes recesses 44, 45, 46, 47, and 48. For example, the upper panels 41 may include the whole of the recesses 44, 45, 46, 47, and 48, or the panels may separately include the recesses 44, 45, 46, 47, and 48. A part or all of the recesses 44, 45, 46, 47, and 48 may be omitted. The recess 44 is formed in the middle portion 40b in the upper surface 40a of the dashboard 40. The recesses 45, 46, 47, and 48 are formed in the side portions 40c in the upper surface 40a of the dashboard 40. The recesses 45, 46, 47, and 48 are formed symmetric at both sides of the middle portion 40b in the dashboard 40.

The recess 44 is more forward than the center panel 43. An upper edge of a rear wall that defines the recess 44 extends to the highest position in the middle portion 40b. An upper edge of a front wall that defines the recess 44 is lower than the upper edge of the rear wall.

The recesses 45 are more rearward than the recesses 46, 47, and 48. A pair of the recesses 45 is formed at each of right and left sides in the vehicle-width direction. The pair of the recesses 45 is aligned in the vehicle-width direction. Each of the recesses 45 is formed into a circle in a plan view. The object to be housed in the recess 45 may be, for example, a cup CP as illustrated in FIG. 5. The recess 45 may be a cup holder holding the cup CP. As illustrated in FIGS. 4 and 5, tops of the side portions 40c may be located between the recesses 45 and the recesses 46, 47, and 48.

Each of the recesses 46 is more forward than the outer recess 45 of the pair of the recesses 45 in the vehicle-width direction. The lateral length of the recess 46 is greater than the longitudinal length thereof in a plan view. The objects to be housed in the recesses 46 are presumably, for example, rectangular plate-shaped objects. Examples of the objects to be housed in the recesses 46 may include a mobile information terminal SF as illustrated in FIG. 5, a purse, a card holder, and an audio device. Each of the recesses 46 may be, for example, a holder that holds the mobile information terminal SF.

The recesses 47 are more forward than the recesses 46. Each of the recesses 48 is more forward than the inner recess 45 of the pair of the recesses 45 in the vehicle-width direction. The recesses 48 are located inner than the recesses 46 and 47 in the vehicle-width direction. The bottom portions of the recesses 47 are higher than those of the recesses 48. As illustrated in FIG. 2, the upper surface 40a of the dashboard 40 may include a single opening as an opening of the recesses 46, 47, and 48. One recess with partitions at the bottom rather than at the opening may be regarded as being divided into the recesses 46, 47, and 48.

The mount bar 50 is disposed upward away from the upper surface 40a of the dashboard 40. A distance between the mount bar 50 and the upper surface 40a of the dashboard 40 can be, but not exclusively, appropriately set. For example, the mount bar 50 may be separated from the upper surface 40a of the dashboard 40 at a distance of 5 cm or longer, preferably 10 cm or longer, and more preferably 20 cm or longer so that the fingers or the hand of the user can be inserted between the mount bar 50 and the upper surface 40a of the dashboard 40. The mount bar 50 includes a main body 51 and vehicle body connectors. The main body 51 is a portion to which accessories can be attached, and is shaped into a rod whose cross-sectional contour is circular. The main body 51 is a pipe according to this embodiment. The vehicle body connectors are portions to be detachably fixed to the vehicle body 12. The vehicle body connectors according to this embodiment are formed at both ends of the main body 51 in the longitudinal direction. Pillar connectors 56 are disposed as the vehicle body connectors according to this embodiment.

The main body 51 includes first portions 52, a second portion 53, and third portions 54. The first portions 52 extend in the vehicle-width direction. The second portion 53 extends more rearward or more upward than the first portions 52 in the vehicle-width direction. Here, the second portion 53 extends more rearward and more upward than the first portions 52 in the vehicle-width direction. The third portions 54 couple the first portions 52 to the second portion 53. The second portion 53 is formed in the middle in the vehicle-width direction. The first portion 52 and the third portion 54 are formed at each of the sides of the second portion 53 along the vehicle-width direction. While the mount bar 50 is attached to the vehicle body 12, the first portions 52 of the main body 51 are disposed at positions corresponding to the upper panels 41 of the dashboard 40. Furthermore, the second portion 53 of the main body 51 is disposed at a position corresponding to the center panel 43 of the dashboard 40. Disposing the second portion 53 away from the first portions 52 in a side view of the vehicle body allows spacing from the center panel 43 of the dashboard 40. Specifically, the second portion 53 is disposed away from the first portions 52 in a direction perpendicular to the vehicle-width direction. In other words, the second portion 53 protrudes from the first portions 52 in a direction in which the center panel 43 protrudes from the upper panels 41 in a side view of the vehicle body.

The first portions 52 and the second portion 53 are parallel or substantially parallel at a crossing angle of 10 degree or less. The first portions 52 according to this embodiment are slightly inclined (e.g., at an inclination of 10 degree or less) in the vehicle-width direction in a plan view as illustrated in FIG. 3. The second portion 53 according to this embodiment is parallel to the vehicle-width direction. The first portions 52 and the second portion 53 according to this embodiment are parallel to the vehicle-width direction in a rear view as illustrated in FIG. 4.

The third portions 54 extend oblique to the forward and backward direction and the vertical direction in a side view of FIG. 1. The third portions 54 extend oblique to the forward and backward direction and the vehicle-width direction in a plan view of FIG. 3. The third portions 54 extend oblique to the vehicle-width direction and the vertical direction in a rear view of FIG. 4.

Each of the third portions 54 includes a straight portion 54a and curved portions 54b. The curved portions 54b are formed at both ends of the straight portion 54a. The curved portion 54b as one end of the third portion 54 is continuous to the first portion 52, and the curved portion 54b as the other end of the third portion 54 is continuous to the second portion 53. The first portions 52 and the second portion 53 extend linearly, similarly to the straight portions 54a. The main body 51 is a component obtained by bending a circular pipe. The pipe is made of a metal or a resin.

The third portions 54 offset the first portions 52 and the second portion 53 in a side view. A direction indicated by an arrow sign A2 in FIG. 1 is the offset direction. An interval between the first portion 52 and the second portion 53 along the offset direction may be, but not exclusively, for example, approximately double to 10 times a diameter of the main body 51.

A virtual line VL in FIG. 1 is a virtual line extending rearward from the second portion 53 extending along the offset direction. The offset direction may be set so that the eyes of the driver DR are located at the end of the virtual line VL in a side view. The eye level of the driver DR of the vehicle 10 in FIG. 1 is a middle height from among heights assumed in a range of the eye levels of the driver DR.

An angle AE in FIG. 6 is an angle formed between the straight portion 54a of the third portion 54 and the horizontal direction in a side view. In other words, the angle AE is an angle of elevation of the straight portion 54a of the third portion 54. The magnitude of the angle AE can be, but not exclusively, appropriately set. The angle AE may range, for example, from approximately 10 degrees to 30 degrees. Furthermore, the angle AE determines a direction of the virtual line VL in FIG. 1. The angle AE may be set so that the eye level of the driver DR at a standard height is located at the end of the virtual line VL.

The mount bar 50 is formed such that the height of the mount bar 50 varies from one point along the vehicle-width direction toward another point along the vehicle-width direction, according to a variation in the height of the dashboard 40. The mount bar 50 according to this embodiment is formed such that the height of the mount bar 50 increases from the first portions 52 that are located at the one point and the other point along the vehicle-width direction toward the second portion 53 in the middle along the vehicle-width direction.

As illustrated in FIGS. 4 and 5, the mount bar 50 is located between a base end of the steering column 35 and the upper edge of the steering wheel 34 in the vertical direction. The mount bar 50 according to this embodiment is located between the upper edge and a lower edge of the steering wheel 34 in the vertical direction. Consequently, the mount bar 50 hardly comes within sight of the driver DR.

The mount bar 50 includes an extending portion displaced from a recess in the forward and backward direction. The mount bar 50 according to this embodiment includes both of a portion extending more forward than a recess and a portion extending more rearward than a recess. The mount bar 50 may include only one of the portions extending more forward than the recesses and the portion extending more rearward than the recess.

The first portions 52 according to this embodiment are the portions extending more forward than the recesses 45 and 46. Since the top of an object housed in each of the recesses 45 and 46 does not interfere with the first portions 52, the cup CP or the smart phone SF which is tall can be housed in the recess 45 or 46. Since the first portions 52 are more forward than the recesses 45 and 46, the first portions 52 hardly interfere with the hand of the user when the user takes in and out an object to and from the recess 45 or 46.

The second portion 53 according to this embodiment is the portion extending more rearward than the recess 44. Since the top of an object housed in the recess 44 does not interfere with the second portion 53, a tall object can be housed in the recess 44.

The first portions 52 of the main body 51 overlap the recesses 47 in a plan view. Furthermore, portions of the third portions 54 closer to the first portions 52 in the main body 51 overlap the recesses 48 in a plan view. Since the main body 51 is upward away from the upper surface 40a of the dashboard 40, the user can take in and out an object to and from the recess 47 or 48 through the space between the main body 51 and the upper surface 40a of the dashboard 40. Since the portions of the recesses 48 overlapping the third portions 54 are partial in a plan view, the user can take in and out an object to and from the recesses 48 through portions of the recesses 48 that do not overlap the third portions 54.

The recesses 45 and 46 are formed apart from the recess 44 in the upper surface 40a of the dashboard 40 in the vehicle-width direction. The mount bar 50 includes the first portions 52 extending more forward of the vehicle 10 than the recesses 45 and 46, and the second portion 53 extending more rearward of the vehicle 10 than the recess 44. The recesses 45 and 46 are examples of a first recess, and the recess 44 is an example of a second recess.

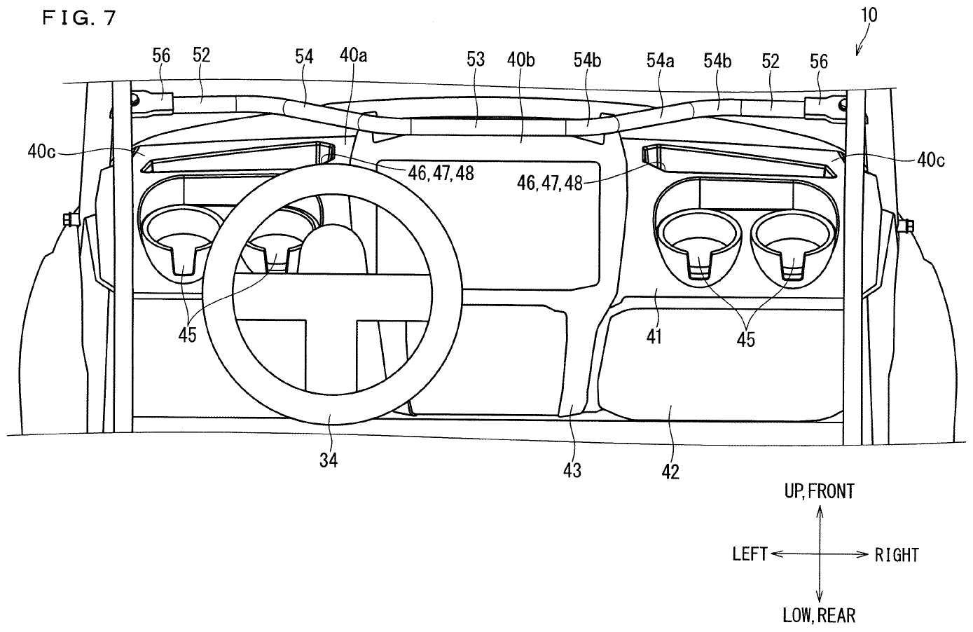

FIG. 7 illustrates a view from a direction along an arrow sign A1 in FIG. 1. FIG. 7 illustrates the vehicle 10 seen externally from above. FIG. 7 illustrates the mount bar 50 seen from a direction along an eye level slightly higher than the eye level corresponding to the virtual line VL. The eye level in FIG. 7 is closer to an eye level at the highest position from among the eye levels assumed as the eye levels of the occupant on the seat 24.

In FIG. 7, the second portion 53 is lower (more rearward) than the first portions 52. The second portion 53 overlaps an upper portion of the center panel 43. Consequently, the second portion 53 hardly blocks the front view of the occupant on the seat 24 through a windshield 70. The first portion 52 to the second portion 53 in the main body 51 are perceived as linear, when seen from the eye level at the virtual line VL.

In FIG. 7, the second portion 53 does not overlap a portion of the center panel 43 into which a navigation system is incorporated. Consequently, the second portion 53 hardly blocks the view of the occupant on the seat 24 when viewing the navigation system.

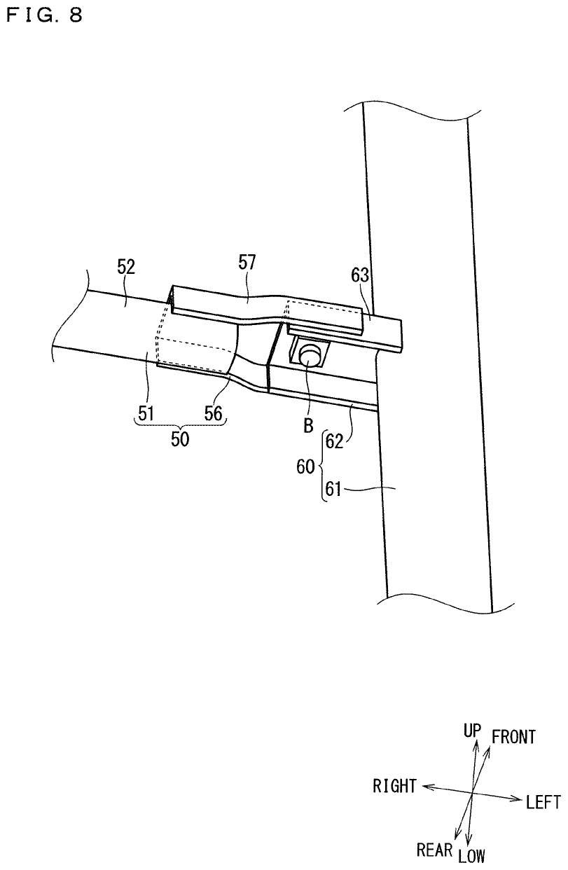

FIG. 8 is a perspective view illustrating a connection portion between the mount bar 50 and the pillar 60.

The mount bar 50 includes the pillar connectors 56 as the vehicle body connectors. The pillar connectors 56 are disposed at both ends along an axial direction of the main body 51. Each of the pillar connectors 56 according to this embodiment includes a bracket 57 disposed separately from the pipe included in the main body 51. The bracket 57 is formed into a shape with a bottom and a pair of side walls. The bracket 57 is made of, for example, a metal or a resin. A portion enclosed by the bottom and the pair of side walls forms a ditch. An end of the main body 51 is located at one end of the ditch. The bracket 57 is fixed to the main body 51 by, for example, welding.

The pillars 60 extend upward from right and left portions more forward than the seat 24 in the vehicle body 12. The pillars 60 may be referred to as A pillars. The pillars 60 in a pair are disposed at both sides, and upper ends thereof are connected through a cross portion. The upper ends of the pillars 60 are connected, through cross portions, to those of the other pillars extending upward from right and left portions more rearward than the seat 24 in the vehicle body 12. Each of the pillars 60 includes a pillar body 61 and a bar connector 62. For example, the pillar body 61 includes a pipe, and the bar connector 62 includes a bracket 63. The pipe and the bracket 63 are made of a metal or a resin. The pillar body 61 mainly extends along the vertical direction. The bar connector 62 protrudes in the vehicle-width direction from a middle portion of the pillar body 61 along an axial direction. The bar connector 62 protrudes inward from the pillar body 61 in the vehicle-width direction. The bar connector 62 may protrude rearward from the pillar body 61. The bar connector 62 overlaps the pillar body 61 in a side view. The bar connector 62 is fixed to the pillar body 61 by, for example, welding.

The end of the mount bar 50 along the axial direction (the pillar connector 56 herein) is connected to the bar connector 62. The end of the bar connector 62 fits into the other end of the ditch of the bracket 57 as the pillar connector 56. Here, the end of the mount bar 50 along the axial direction is formed into a structure covering the bar connector 62 from the top. Specifically, the bracket 57 of the pillar connector 56 is formed into a shape with the bottom and the pair of side walls, the bottom of the bracket 57 covers an upper portion of the bar connector 62, and the pair of side walls extending downward from both side edges of the bottom covers both sides of the bar connector 62 as illustrated in FIG. 8. The pillar connector 56 is fixed to the bar connector 62 by fastening a fastening component B such as a bolt B. A through hole 58 and a through hole 64 through which the fastening component B passes are formed on the pillar connector 56 and the bar connector 62, respectively. One of the through hole 58 on the pillar connector 56 and the through hole 64 on the bar connector 62 may be formed into a long hole in the vehicle-width direction.

The pipe included in the main body 51 of the mount bar 50 may be thinner than the pipe included in the pillar body 61. The pipe included in the main body 51 of the mount bar 50 may be as thick as or thicker than the pipe included in the pillar body 61.

The vehicle body 12 (the pillars 60 herein) supports both ends of the mount bar 50. The middle portion of the mount bar 50 except the ends is suspended in air without being supported by the vehicle body 12. For example, the thickness of the pipe included in the main body 51 is set to have a stiffness for carrying a certain load including, for example, the accessories while the pipe is suspended in air. The vehicle body 12 may support a part of the middle portion of the mount bar 50.

The mount bar 50 includes outside portions overlapping the pillars 60 through the bar connectors 62 and extending inward in the vehicle-width direction in a side view. As illustrated in FIG. 5, the end of the straight portion 54a of the third portion 54 which is closer to the second portion 53 protrudes more rearward than the pillar 60. Thus, the outside portions overlapping the pillars 60 are portions of the mount bar 50 from the pillar connectors 56 to portions of the ends of the third portions 54 that are continuous to the first portions 52 in a side view.

As illustrated in FIG. 1, the vehicle 10 according to this embodiment includes the windshield 70. The windshield 70 is connected to the pillars 60. In the example of FIG. 1, the windshield 70 is divided into a first shield 71 and a second shield 72. The first shield 71 is connected to the pillars 60. The second shield 72 is rotatably coupled to the first shield 71 through a hinge. The user can rotate the second shield 72 as necessary.

Each of the pillars 60 includes an upper connector 65 and a lower connector 66 to which an upper portion and a lower portion of the windshield 70 are connected, respectively. Here, the upper portions of the first shield 71 are connected to the upper connectors 65, and the lower portions of the first shield 71 are connected to the lower connectors 66. As illustrated in FIG. 4, etc., the bar connectors 62 are located between the upper connectors 65 and the lower connectors 66.

The ends of the mount bar 50 extend along the rear surface of the windshield 70. Here, portions from the pillar connectors 56 to the first portions 52 in the mount bar 50 extend along the rear surface of the first shield 71. The third portions 54 extend rearward away from the rear surface of the first shield 71.

A roof, which is not illustrated, may be supported at the top of the pillars 60. In this case, the vehicle 10 may include the roof. The roof spreads to cover the seats 24 and 25 from the top, above the seats 24 and 25. The roof can provide the occupants with a sunshade and a weather shield. The roof may spread in the forward and backward direction from a position in front of the steering wheel 34 toward a position behind the back rest of the seat 25. The roof may spread to cover the whole of the seats 24 and 25 in the lateral direction.

The vehicle 10 may include other pillars that support the roof together with the pillars 60. The vehicle 10 according to this embodiment includes intermediate pillars 18 and rear pillars 20. The intermediate pillars 18 extend upward from the back rest of the seat 24. The rear pillars 20 extend upward from behind the back rest cushion 25b of the seat 25. The intermediate pillars 18 or the rear pillars 20 may extend from, for example, the floor except the seats 24 and 25. The number of the pillars 18, 20, and 60 is discretionary. For example, the intermediate pillars 18 may be omitted.

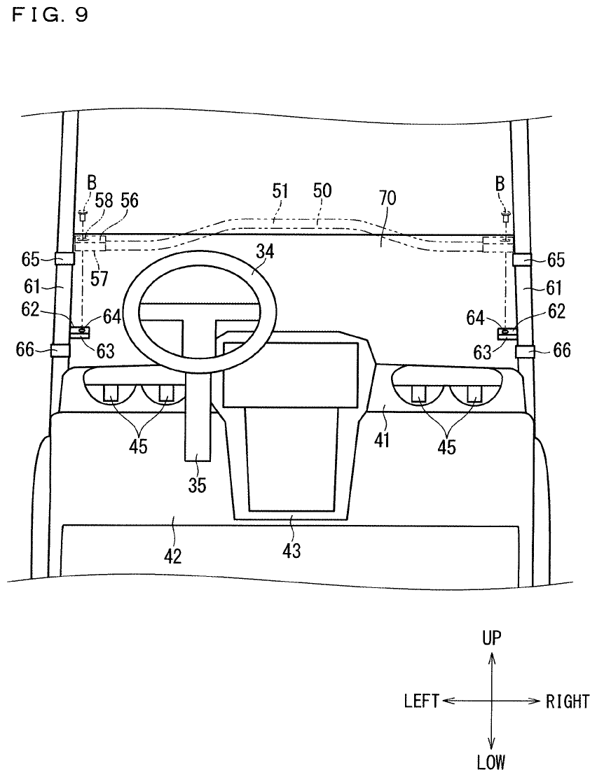

FIG. 9 is a rear view illustrating a state in which the mount bar 50 has been removed.

The ends of the mount bar 50 are detachably connected to the bar connectors 62. Here, removal of the fastening components B for fastening the pillar connectors 56 to the bar connectors 62 can remove the mount bar 50 from the bar connectors 62. Here, the bolts B are provided as the fastening components B. Each of the bolts B includes a head and a screw. Here, the bolts B are inserted into the through holes 58 and 64 along the vertical direction and fastened thereto. The head is higher than the screw in each of the bolts B. Thus, the fastening components B are easily accessible to the user. The fastening components B may be, for example, rivets or clamps except the bolts B. Furthermore, the ends of the mount bar 50 may be detachable from the bar connectors 62 through a locking structure without the fastening components B.

The bar connectors 62 according to this embodiment can support the pillar connectors 56 at certain positions without fastening the bolts B. Consequently, the operator need not support the mount bar 50 while performing an operation of fastening the bolts B. Here, the brackets 63 of the bar connectors 62 support the brackets 57 of the pillar connectors 56 from the bottom. Here, engagement of the brackets 63 of the bar connectors 62 to the ditches of back sides of the brackets 57 of the pillar connectors 56 supports the mount bar 50 at the certain positions in the forward and backward direction. Furthermore, the pillar bodies 61 can restrict the movement of the mount bar 50 in the vehicle-width direction by disposing the mount bar 50 between the pillar bodies 61. This supports the mount bar 50 at the certain positions in the vehicle-width direction. As illustrated in FIG. 8, a width of a portion of the ditch of the back side of the bracket 57 into which the end of the main body 51 fits is less than that of a portion into which the bracket 63 fits. This restricts at least a predetermined amount of movement of the brackets 63 toward the main body 51 along the ditches of the brackets 57, and supports the mount bar 50 at the certain positions in the vehicle-width direction. Supporting the mount bar 50 in the forward and backward direction and the vehicle-width direction at the certain positions determines the positions of the through holes 58 and 64 in the forward and backward direction and the vehicle-width direction, and facilitates the operation of fastening the bolts B. These facilitate an operation of detaching the mount bar 50.

Removal of both ends of the mount bar 50 from the bar connectors 62 can create a situation in which the mount bar 50 has been removed from the vehicle 10. The vehicle 10 may travel with the mount bar 50 being removed from the vehicle 10. The mount bar 50 removed from the vehicle 10 can be attached to the bar connectors 62 again. Thus, the user can attach or detach the mount bar 50 to and from the vehicle 10 as necessary.

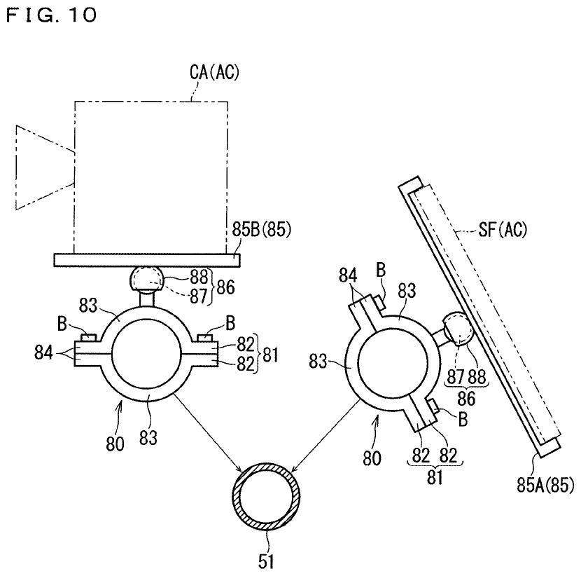

FIG. 10 illustrates examples of the accessories AC to be attached to the mount bar 50.

FIG. 10 illustrates the smart phone SF and a camera CA as the examples of the accessories AC. The accessories AC to be attached to the mount bar 50 can be, but not exclusively, appropriately set. Examples of the accessories AC may include a tablet terminal, a video camera, a dashcam, an audio device, a speaker, a display, and a laptop.

The accessories AC are attached to the mount bar 50, for example, through support components 80. FIG. 10 illustrates examples of the support components 80 for attaching the accessories AC to the mount bar 50. Each of the support components 80 includes an attachment part 81 to be attached to the mount bar 50, and a supporter 85 supporting the accessory AC.

The structure of the attachment part 81 can be, but not exclusively, appropriately set as long as the attachment part 81 can be attached to the main body 51 of the mount bar 50. When the main body 51 is a pipe, the attachment part 81 may be a general-purpose pipe clamp. FIG. 10 illustrates, as examples of the attachment parts 81, pipe clamps of a type that is fastened to the main body 51 of the mount bar 50 while sandwiching the main body 51. Each of the attachment parts 81 includes a pair of halves 82. Each of the halves 82 includes a semicylindrical portion 83 and flanges 84. The main body 51 of the mount bar 50 passes between a pair of the semicylindrical portions 83. The flanges 84 protrude from both ends of the semicylindrical portions 83 outward in a radial direction of the semicylindrical portions 83. The fastening components B such as the bolts B are fastened to overlapping portions of the flanges 84 of the pair of halves 82. The attachment part 81 can rotate around the axis of the main body 51 while the bolts B are not firmly fastened. Besides, the attachment part 81 may be, for example, a hinged pipe clamp in which one end of the pair of the semicylindrical portions 83 is coupled via a hinge. For example, the pair of the semicylindrical portions 83 may maintain a closed state without using the fastening components B, by biasing the pair of the semicylindrical portions 83 in a closing direction through a spring, as used in a clothespin.

The structure of the supporters 85 can be, but not exclusively, appropriately set as long as the supporters 85 can support the accessories AC. For example, each of the supporters 85 may be arranged to sandwich the accessory AC, or arranged to be fastened together with the accessory AC. Each of the supporters 85 may be appropriately set according to the type of the accessory AC. FIG. 10 illustrates, for example, a supporter 85A that can hold the outer edge of the smart phone SF as the supporter 85A when the accessory AC is the smart phone SF. FIG. 10 also illustrates, for example, a supporter 85B formed into a base plate to be able to fasten the camera CA as the supporter 85B when the accessory AC is the camera CA.

The attachment part 81 may be formed integrally with the supporter 85. The attachment part 81 may be formed separately from the supporter 85 as illustrated in the example of FIG. 10. When the attachment part 81 is formed separately from the supporter 85, the supporter 85 may be detachable from the attachment part 81. This enables the supporter 85 to be replaced according to the type of the accessory AC.

When the attachment part 81 is formed separately from the supporter 85, a structure for attaching the supporter 85 to the attachment part 81 can be, but not exclusively, appropriately set. The supporter 85 may be attached to the attachment part 81 so that their attitudes are changeable or unchangeable. When the supporter 85 is attached to the attachment part 81 so that the attitudes are changeable, the attachment part 81 and the supporter 85 may be rotatable around an axis or axes, or movable along an axis or axes. For example, the supporters 85 may be attached to the attachment parts 81 through respective ball joints 86 as illustrated in the example of FIG. 10. Each of the ball joints 86 includes a ball 87 and a socket 88. The socket 88 is formed into a shell surrounding the ball 87, and the ball 87 engages in the socket 88. Here, the ball 87 is disposed on one of the pair of halves 82, and the socket 88 is disposed on the supporter 85. Here, the socket 88 may be disposed on the halve 82, and the ball 87 may be disposed on the supporter 85. Each of the support components 80 may include a linkage for coupling the supporter 85 to the halve 82. Here, one of the ball 87 and the socket 88 may be disposed on the halve 82 and the supporter 85 in common, and the other of the ball 87 and the socket 88 may be disposed at both sides of the linkage.

The attachment parts 81 can be attached around the axis of the main body 51 in discretionary directions. Thus, each of the balls 87 can be located at a discretionary position in a circumferential direction of the main body 51. Furthermore, each of the sockets 88 can rotate around numerous axes of the ball 87 within a predetermined range. These can adjust the orientation of each of the accessories AC in a discretionary direction to suit the preference of the user.

### [Advantages]

Since the cross-sectional contour of the main body 51 of the mount bar 50 is circular in the mount bar 50 with the aforementioned structure and the vehicle 10 including this mount bar 50, the accessories AC can be attached at discretionary angles around the axis. Consequently, the various accessories AC can be attached to the mount bar 50 with attitudes desired by the user, which can increase the convenience of the user.

Since the cross-sectional contour of the main body 51 of the mount bar 50 is circular, examples of the support components 80 may include a general-purpose mount component that can be attached to, for example, a bicycle handlebar. This can also increase the convenience of the user.

Furthermore, the mount bar 50 is disposed upward away from the upper surface 40a of the dashboard 40. This can prevent narrowing the riding space for occupants more than that when the mount bar 50 is disposed rearward apart from the dashboard 40, and can prevent the inconvenience in getting on or off of the occupants and reduction in the usability.

Furthermore, the pillars 60 each include the bar connector 62 to which the pillar connector 56 disposed along the axial direction of the mount bar 50 is connected. Consequently, connection of the mount bar 50 to the pillars 60 can prevent complication of the structures of the dashboard 40 and a cover for the steering column 35 more than that when, for example, the dashboard 40 and the cover support the mount bar 50.

The pillar connectors 56 at the ends of the mount bar 50 are detachably connected to the bar connectors 62. Thus, the mount bar 50 can be attached or detached to and from the vehicle 10 as necessary.

Furthermore, each of the ends of the mount bar 50 along the axial direction is formed into a structure covering the bar connector 62 from the top. This can prevent accumulation of rainwater at the ends of the mount bar 50 along the axial direction. This also improves the appearance of the connection portions between the mount bar 50 and the pillars 60.

The mount bar 50 includes the first portions 52 as the outside portions overlapping the pillars 60 through the bar connectors 62 and extending inward in the vehicle-width direction in a side view. Consequently, the mount bar 50 is disposed between the pillars 60. Thus, the riding space can be widened more than that when the mount bar 50 extends rearward from the pillars 60.

Each of the pillars 60 includes the upper connector 65 and the lower connector 66 to which the upper portion and the lower portion of the windshield 70 are connected, respectively, and the bar connectors 62 are located between the upper connectors 65 and the lower connectors 66. This can reduce interference in the pillars 60 between the bar connectors 62 and the connection portions of the windshield 70.

Furthermore, the first portions 52 and the pillar connectors 56 at the ends of the mount bar 50 extend along the rear surface of the windshield 70. This can dispose the mount bar 50 in front of the riding space to the extent possible.

Furthermore, the mount bar 50 includes: the first portions 52 extending in a vehicle-width direction; the second portion 53 extending in the vehicle-width direction more rearward or more upward than the first portions 52; and the third portions 54 coupling the first portions 52 to the second portion 53. Consequently, making the first portions 52 and the second portion 53 different in the forward and backward direction can create different attachment positions to suit the preference of the user. For example, the accessory AC attached to the second portion 53 can be disposed closer to the occupant than that when the accessory AC is attached to the first portion 52.

Furthermore, the third portions 54 extend oblique to the forward and backward direction and the vehicle-width direction in a plan view. This can reduce the amount of bending in the third portions 54 and facilitates increasing the stiffness of the third portions 54 along an axial direction, more than those when the third portions 54 extend in a direction orthogonal to the first portions 52.

Furthermore, the second portion 53 is higher than the first portions 52, and the third portions 54 extend oblique to the forward and backward direction and the vertical direction in a side view. This can reduce an area of sight to be blocked by the mount bar 50 when the occupant in a driving position views forward and downward in the vehicle body 12.

Furthermore, the upper surface 40a of the dashboard 40 is formed such that a height of the dashboard 40 varies from one point along the vehicle-width direction toward another point along the vehicle-width direction. The mount bar 50 is formed such that a height of the mount bar 50 varies from one point along the vehicle-width direction toward another point along the vehicle-width direction, according to the variation in the height of the dashboard 40. This can prevent interference between the accessory AC attached to the mount bar 50 and the dashboard 40 under conditions even when the accessory AC is attached to a discretionary position in the vehicle-width direction.

The second portion 53 is formed in the middle in the vehicle-width direction, and the first portions 52 are formed at both sides of the second portion 53 along the vehicle-width direction. This can dispose a middle portion of the mount bar 50 in the vehicle-width direction closer to the occupant. A component to be mounted on the second portion 53 is easily accessible to both of the driver DR and the occupant on the assistant driver seat.

Furthermore, the mount bar 50 is located between the base end of the steering column 35 and the steering wheel in the vertical direction. This can prevent the mount bar 50 from coming within sight of the driver too much, while the mount bar 50 is located in a position accessible to the driver.

The mount bar 50 further includes the first portions 52 and the second portion 53 extending in the forward and backward direction at positions displaced from the recesses 44, 45, and 46 formed on the upper surface 40a of the dashboard 40. This can reduce interference between objects that lean against the recesses 44, 45, and 46 and the mount bar 50.

The mount bar 50 further includes the first portions 52 extending more forward of the vehicle 10 than the recesses 45 and 46 formed on the upper surface 40a of the dashboard 40. Consequently, the object to be housed in the recess 45 or 46 can be easily taken in and out while interference with the mount bar 50 is prevented.

The mount bar 50 further includes the first portions 52 extending more forward of the vehicle 10 than the first recesses 45 and 46, and the second portion 53 extending more rearward of the vehicle 10 than the second recess 44. Consequently, the mount bar 50 hardly interferes with the object to be housed in the first recess 45 or 46 and the object to be housed in the second recess 44.

The main body 51 of the mount bar 50 is a component obtained by bending a circular pipe. This facilitates manufacturing of the mount bar 50. Furthermore, the main body 51 of the mount bar 50 includes the straight portions 54a and the curved portions 54b. The straight portions 54a can reduce the bending shape, and facilitate manufacturing of the mount bar 50.

### [Other Modifications]

The mount bar 50 may be disposed except above the upper surface 40a of the dashboard 40. Furthermore, the cross-sectional contour of the main body 51 of the mount bar 50 may be a shape except a circle.

While the mount bar 50 is attached to the vehicle body 12, the second portion 53 is displaced upward and rearward with respect to the first portions 52 in the embodiment. Without being limited to this, the second portion 53 may be displaced upward or rearward. Furthermore, the second portion 53 may be displaced in a direction except upward and rearward directions with respect to the first portions 52. Although this embodiment discloses two parallel portions whose attachment positions can differ in the main body 51, three or more parallel portions may be formed in the main body of the mount bar. Although the mount bar 50 is formed across both of the driver seat and the assistant driver seat, the mount bar may be disposed across only one of the driver seat and the assistant driver seat.

Although the main body 51 preferably has a shape that conforms to the upper surface 40a of the dashboard 40, the main body 51 may be formed into a shape that does not conform to the upper surface 40a of the dashboard 40 as long as the cross-sectional shape of the main body 51 is circular.

Although the cross-sectional shape of the main body 51 is preferably circular, the cross-sectional shape may be a shape except a circle as long as the main body 51 is formed into a shape that conforms to the upper surface 40a of the dashboard 40. For example, a middle portion of the main body 51 may have a bent shape with respect to both ends in the axial direction so that the middle portion conforms to the center panel 43 of the dashboard 40. Alternatively, the main body 51 need not conform to the center panel 43 of the dashboard 40. In this case, arranging the middle portion of the main body 51 with a bend with respect to both ends enables attachment of the accessories AC at different positions in the middle portion and a non-middle portion. This facilitates implementing the attachment to suit the preference of the operator.

Although the embodiment describes that the vehicle 10 includes the seats 24 and 25, this structure is not essential. The vehicle may include only the seat 24 without the seat 25. The vehicle may further include a seat more rearward than the seat 25.

Although the embodiment describes that the vehicle 10 does not include doors at both sides of the seats 24 and 25, this structure is not essential. The vehicle may include doors at both sides of the seats 24 and 25.

The vehicle 10 may include or need not include a roof.

Although the embodiment describes that the vehicle 10 includes the pillars 60, this structure is not essential. The vehicle may include a rollover protective structure (ROPS) for defining a riding space, instead of the pillars 60.

Although the embodiment assumes that the driver drives the vehicle 10, this structure is not essential. The vehicle may be an automated driving vehicle. The vehicle may be configured to switch between an automated driving mode and a mode in which the driver drives the vehicle.

The vehicle may be a passenger transport vehicle. The passenger transport vehicle is a vehicle designed to travel at low speeds within a limited area. Examples of the limited area include limited community areas, and private roads and private lands (e.g., golf courses and parks) except public roads. The limited community areas may be areas provided for use by community residents. The community areas are, for example, areas including houses and public facilities (e.g., schools and hospitals), and are areas in which the passenger transport vehicle designed to travel through non-public highways is permitted to travel at low speeds. The low speeds are, for example, speeds with upper limits ranging from 20 mph to 30 mph. The passenger transport vehicles include personal transport vehicles (PTVs) in accordance with ANSI/ILTVA Z135, and golf carts in accordance with ANSI/ILTVA Z130.1. Furthermore, the passenger transport vehicles include personal transportation electric vehicles.

Passenger transport vehicles may be, for example, versatile small vehicles suitable for traveling through limited off-road areas rather than traveling through public roads at fast speeds. Off-road vehicles may be, for example, side-by-side vehicles. The side-by-side vehicles are, for example, small vehicles suitable for all terrain travel, particularly, off-road travel, and vehicles in which occupants can be seated side by side. The side-by-side vehicles may be, for example, multipurpose off-highway utility vehicles (MOHUVs) defined by ANSI/OPEI B71.9-2016, and recreational off-highway vehicles defined by ANSI/ROHVA 1-2016.

Although described is that the vehicle 10 travels within a limited area, this structure is not essential. The vehicle 10 may be a vehicle that can travel through public roads.

The structures described in the embodiment and the modifications can be appropriately combined unless any contradiction occurs.

### [Appendixes]

This application discloses the following aspects.

A first aspect is a vehicle comprising: a dashboard; and a mount bar including a rod-shaped main body whose cross-sectional contour is circular, the mount bar being formed along the dashboard.

Since the cross-sectional contour of the main body of the mount bar is circular in this vehicle, accessories can be attached at discretionary angles around the axis. Consequently, the various accessories can be attached to the mount bar with attitudes desired by the user, which can increase the convenience of the user.

A second aspect is the vehicle according to the first aspect, wherein the mount bar is disposed upward away from the upper surface of the dashboard.

This can prevent narrowing the riding space for occupants more than that when the mount bar is disposed rearward apart from the dashboard, and can prevent the inconvenience in getting on or off of the occupants and reduction in the usability.

A third aspect is the vehicle according to the first aspect, the vehicle comprising pillars each including a bar connector to which an end of the mount bar is connected along an axial direction.

In this case, connection of the mount bar to the pillars can prevent complication of the structures of the dashboard and a cover for the steering column more than that when the dashboard and the cover support the mount bar.

A fourth aspect is the vehicle according to o the third aspect, wherein the ends of the mount bar are detachably connected to the bar connectors.

In this case, the mount bar can be attached or detached to and from the vehicle as necessary.

A fifth aspect is the vehicle according to the third aspect, wherein each of the ends of the mount bar along the axial direction is formed into a structure covering the bar connector from a top.

This can prevent accumulation of rainwater at the ends of the mount bar along the axial direction.

A sixth aspect is the vehicle according to the third aspect, wherein the mount bar includes outside portions overlapping the pillars through the bar connectors and extending inward in a vehicle-width direction in a side view.

In this case, the mount bar is disposed between the pillars. Thus, the riding space can be widened more than that when the mount bar extends rearward from the pillars.

A seventh aspect is the vehicle according to the third aspect, wherein each of the pillars includes an upper connector and a lower connector to which an upper portion and a lower portion of a windshield are connected, respectively, and the bar connectors are located between the upper connectors and the lower connectors.

This can reduce interference in the pillars between the bar connectors and the connection portions of the windshield.

An eighth aspect is the vehicle according to the third aspect, the vehicle comprising a windshield connected to the pillars, wherein the ends of the mount bar extend along a rear surface of the windshield.

This can dispose the mount bar in front of the riding space to the extent possible.

A ninth aspect is the vehicle according to the first aspect, wherein the mount bar includes: at least one first portion extending in a vehicle-width direction; a second portion extending in the vehicle-width direction more rearward or more upward than the at least one first portion; and a third portion coupling the at least one first portion to the second portion.

In this case, making the first portion and the second portion different in the forward and backward direction can create different attachment positions to suit the preference of the user. For example, the accessory attached to the second portion can be disposed closer to the occupant than that when the accessory is attached to the first portion.

A tenth aspect is the vehicle according to the ninth aspect, wherein the third portion extends oblique to a forward and backward direction and the vehicle-width direction in a plan view.

This can reduce the amount of bending in the third portion and facilitates increasing the stiffness of the third portion along the axial direction, more than those when the third portion extends in a direction orthogonal to the first portion.

An eleventh aspect is the vehicle according to the ninth aspect, wherein the second portion is higher than the at least one first portion, and the third portion extends oblique to a forward and backward direction and a vertical direction in a side view.

This can reduce an area of sight to be blocked by the mount bar when the occupant in a driving position views forward and downward in the vehicle body.

A twelfth aspect is the vehicle according to the ninth aspect, wherein a driver seat on one side in the vehicle-width direction and an assistant driver seat on an other side in the vehicle-width direction are disposed to sandwich a middle in the vehicle-width direction, the second portion is formed in the middle in the vehicle-width direction, and the at least one first portion comprises first portions at both sides of the second portion in the vehicle-width direction.

This can dispose a middle portion of the mount bar in the vehicle-width direction closer to the occupant. A component to be mounted on the second portion is easily accessible to both of the driver and the assistant driver.

A thirteenth aspect is the vehicle according to the second aspect, wherein the upper surface of the dashboard is formed such that a height of the dashboard varies from one point along the vehicle-width direction toward an other point along the vehicle-width direction, and the mount bar is formed such that a height of the mount bar varies from one point along the vehicle-width direction toward an other point along the vehicle-width direction, according to the variation in the height of the dashboard.

This can prevent interference between the accessory attached to the mount bar and the dashboard under conditions even when the accessory is attached to a discretionary position in the vehicle-width direction.

A fourteenth aspect is the vehicle according to the first aspect, wherein the mount bar is located between a base end of a steering column and a steering wheel in a vertical direction.

This can prevent the mount bar from coming within sight of the driver too much, while the mount bar is located in a position accessible to the driver.

A fifteenth aspect is the vehicle according to the second aspect, wherein the upper surface of the dashboard includes a recess with an upper opening for housing an object, and the mount bar includes an extending portion displaced from the recess in a forward and backward direction.

This can reduce interference between an object that leans against the recess and the mount bar.

A sixteenth aspect is the vehicle according to the second aspect, wherein the upper surface of the dashboard includes a recess with an upper opening for housing an object, and the mount bar includes a portion extending more forward of the vehicle than the recess.

In this case, the object to be housed in the recess can be easily taken in and out while interference with the mount bar is prevented.

A seventeenth aspect is the vehicle according to the second aspect, wherein the upper surface of the dashboard includes a first recess and a second recess which are formed apart in a vehicle-width direction, and the mount bar includes a portion extending more forward of the vehicle than the first recess and a portion extending more rearward of the vehicle than the second recess.

Consequently, the mount bar hardly interferes with the object to be housed in the first recess and the object to be housed in the second recess.

An eighteenth aspect is the vehicle according to the first aspect, wherein the main body of the mount bar is a component obtained by bending a circular pipe, and the main body of the mount bar includes a straight portion and a curved portion.

Since the main body of the mount bar is a component obtained by bending a circular pipe, manufacturing of the mount bar is facilitated. Furthermore, the straight portion can reduce the bending shape, and facilitates manufacturing of the mount bar.

A nineteenth aspect is a vehicle comprising: a dashboard; and a mount bar disposed upward away from an upper surface of the dashboard.

This can prevent narrowing the riding space for occupants more than that when the mount bar is disposed rearward apart from the dashboard, and can prevent the inconvenience in getting on or off of the occupants and reduction in the usability.

A twentieth aspect is a mount bar disposed along a dashboard of a vehicle, the mount bar comprising: a main body whose cross-sectional contour is circular; and connectors at both ends along an axial direction of the main body, wherein a middle portion of the main body is arranged with a bend with respect to the ends in the axial direction.

In this mount bar, arranging the ends and the middle portion with bends in the axial direction enables attachment of accessories at different positions to suit the preference of the user. Since the cross-sectional contour of the main body of the mount bar is circular, the accessories can be attached at discretionary angles around the axis.

The foregoing description is in all aspects illustrative and does not restrict this invention. Numerous modifications and variations that have not yet been exemplified are devised without departing from the scope of this invention.

1. A vehicle, comprising:
a dashboard; and
a mount bar including a rod-shaped main body whose cross-sectional contour is circular, the mount bar being formed along the dashboard.

2. The vehicle according to claim 1,
wherein the mount bar is disposed upward away from an upper surface of the dashboard.

3. The vehicle according to claim 1, comprising
pillars each including a bar connector to which an end of the mount bar is connected along an axial direction.

4. The vehicle according to claim 3,
wherein the ends of the mount bar are detachably connected to the bar connectors.

5. The vehicle according to claim 3,
wherein each of the ends of the mount bar along the axial direction is formed into a structure covering the bar connector from a top.

6. The vehicle according to claim 3,
wherein the mount bar includes outside portions overlapping the pillars through the bar connectors and extending inward in a vehicle-width direction in a side view.

7. The vehicle according to claim 3,
wherein each of the pillars includes an upper connector and a lower connector to which an upper portion and a lower portion of a windshield are connected, respectively, and
the bar connectors are located between the upper connectors and the lower connectors.

8. The vehicle according to claim 3, comprising
a windshield connected to the pillars,
wherein the ends of the mount bar extend along a rear surface of the windshield.

9. The vehicle according to claim 1,
wherein the mount bar includes: at least one first portion extending in a vehicle-width direction; a second portion extending in the vehicle-width direction more rearward or more upward than the at least one first portion; and a third portion coupling the at least one first portion to the second portion.

10. The vehicle according to claim 9,
wherein the third portion extends oblique to a forward and backward direction and the vehicle-width direction in a plan view.

11. The vehicle according to claim 9,
wherein the second portion is higher than the at least one first portion, and
the third portion extends oblique to a forward and backward direction and a vertical direction in a side view.

12. The vehicle according to claim 9,
wherein a driver seat on one side in the vehicle-width direction and an assistant driver seat on an other side in the vehicle-width direction are disposed to sandwich a middle in the vehicle-width direction,
the second portion is formed in the middle in the vehicle-width direction, and
the at least one first portion comprises first portions at both sides of the second portion in the vehicle-width direction.

13. The vehicle according to claim 2,
wherein the upper surface of the dashboard is formed such that a height of the dashboard varies from one point along the vehicle-width direction toward an other point along the vehicle-width direction, and
the mount bar is formed such that a height of the mount bar varies from one point along the vehicle-width direction toward an other point along the vehicle-width direction, according to the variation in the height of the dashboard.

14. The vehicle according to claim 1,
wherein the mount bar is located between a base end of a steering column and a steering wheel in a vertical direction.

15. The vehicle according to claim 2,
wherein the upper surface of the dashboard includes a recess with an upper opening for housing an object, and
the mount bar includes an extending portion displaced from the recess in a forward and backward direction.

16. The vehicle according to claim 2,
wherein the upper surface of the dashboard includes a recess with an upper opening for housing an object, and
the mount bar includes a portion extending more forward of the vehicle than the recess.

17. The vehicle according to claim 2,
wherein the upper surface of the dashboard includes a first recess and a second recess which are formed apart in a vehicle-width direction, and
the mount bar includes a portion extending more forward of the vehicle than the first recess and a portion extending more rearward of the vehicle than the second recess.

18. The vehicle according to claim 1,
wherein the main body of the mount bar is a component obtained by bending a circular pipe, and
the main body of the mount bar includes a straight portion and a curved portion.

19. A vehicle, comprising:
a dashboard; and
a mount bar disposed upward away from an upper surface of the dashboard.

20. A mount bar disposed along a dashboard of a vehicle, the mount bar comprising:
a main body whose cross-sectional contour is circular; and
connectors at both ends along an axial direction of the main body,
wherein a middle portion of the main body is s arranged with a bend with respect to the ends in the axial direction.
